(19) United States
(12) Patent Application Publication
(10) Pub. No.: US 2026/0355813 A1
(43) Pub. Date: Nov. 12, 2026

(54) LIQUID METAL DETECTION SYSTEM

(71) Applicant: VESUVIUS-SERT, SAS, Decines-Charpieu (FR)

(72) Inventors: Julien Grasser, Decines-Charpieu (FR); Florian Perrichon, Decines-Charpieu (FR); Corentin Picard, Decines-Charpieu (FR)

(73) Assignee: VESUVIUS-SERT, SAS, Decines-Charpieu (FR)

(21) Appl. No.: 19/487,139

(22) PCT Filed: May 29, 2024
(86) PCT No.: PCT/EP2024/064780

§ 371 Date: Nov. 24, 2025

(30) Foreign Application Priority Data
May 30, 2023 (EP) 23176162.8

(51) Int. Cl. B22D 2/00; B22D 11/14; G01F 23/26

(52) U.S. Cl. CPC B22D 2/003; B22D 11/14; G01F 23/26

(57) ABSTRACT

A detecting system for monitoring and/or controlling liquid metal during a metal-making process is provided. The system includes an electromagnetic sensor with an excitation coil and a receiver, an AC current unit for energizing the excitation coil, a synchronization circuit and a controller. The synchronization circuit includes an input terminal for receiving one or more AC phase voltages from a three-phase power supply, and wherein the synchronization circuit is configured for outputting a pulse train having a pulse train frequency f_{P} with f_{P}=M×f_{AC} and wherein M is an integer number with M≥1, and wherein f_{AC} is a frequency of an AC cycle associated to the one or more AC phase voltages. The controller is configured for controlling the electromagnetic sensor in a batch mode. The controller is further configured for receiving the pulse train.

### FIELD OF THE DISCLOSURE

The present disclosure relates to a detecting system for monitoring and/or controlling liquid metal during a metal-making process. More specifically, it relates to a detection system comprising an electromagnetic sensor.

### BACKGROUND

During metal-making processes, such as for instance continuous casting, electromagnetic sensors are commonly used for detecting certain parameters such as for example a level of molten steel in a continuous caster mold or a liquid steel flow-rate through a continuous caster mold.

Generally, the electromagnetic sensors used for liquid metal detection comprise an excitation coil for generating a magnetic field interacting with the liquid metal being processed, for example liquid steel in a mold during continuous casting. An AC current source is used for powering the excitation coil and generating a varying magnetic field. The magnetic field from the excitation coil induces eddy currents in the molten metal which in turn will vary the magnetic field. Indeed, it is known that eddy currents generate a secondary magnetic field opposing the primary magnetic field having caused the eddy currents. The electromagnetic sensor comprises a receiver, typically equipped with at least one receiver coil, for receiving one or more response signals that are revealing the variation of the magnetic field caused by the eddy currents in the liquid metal.

In the steel industry, the electromagnetic sensors are for example used for determining a level of liquid metal, e.g. liquid steel, in a mold during continuous casting. Indeed, the level of the liquid metal is a critical parameter that needs to be carefully monitored and controlled to ensure for instance the proper dimensions and quality of the final product.

The electromagnetic sensors are sensitive for detection of a variation of the level in a continuous caster mold. Indeed, when the level of metal in the mold rises or reduces, the magnetic field sensed by the receiver coil will vary. Generally, before operating the electromagnetic sensor, a calibration is performed to establish a relation between the magnetic field variation detected and the level of liquid metal in the mold.

In U.S. Pat. No. 8,714,234B2, an example of an electromagnetic sensor is described wherein the sensor is positioned at an outer periphery of a continuous caster mold for measuring a level of molten metal during a continuous casting process. In this example, the electromagnetic sensor is at least partly enclosed by a metal housing which is water cooled in order to be well insulated from the molten metal in the mold. In these embodiments, the AC current source for energizing the excitation coil is operating in a range between 400 Hz and 1500 Hz.

Although electromagnetic sensors have proven to be valuable detectors for use in metal-making processes, especially due to their accuracy and non-invasive nature, an important challenge remains. Indeed, a problem with electromagnetic sensors is that they are susceptible to external electromagnetic disturbances, e.g. effects of electromagnetic interference. This electromagnetic interference can come from a variety of sources, such as electrical equipment, motors, and power supplies located in the environment of the electromagnetic sensor.

As a result of these electromagnetic disturbances, the accuracy of the electromagnetic sensor is reduced.

Hence, there is room for improving detecting systems for monitoring and/or controlling liquid metal during a metal-making process.

### SUMMARY

It is an object of the present disclosure to provide a detecting system for monitoring and/or controlling liquid metal during a metal-making process wherein the effects of electromagnetic disturbances are reduced when compared to known prior art detection systems and hence to improve detection accuracy.

The invention is, at least in part, based on the inventors observation that the electromagnetic disturbance that is perturbating the response signals detected with the electromagnetic sensor is mainly of a repetitive nature. In other words, the electromagnetic disturbance can be construed as a signal having a repeated pattern.

Indeed, measurements performed with for example an electromagnetic sensor of the type as described in U.S. Pat. No. 8,714,234B2, reveals the presence of an electromagnetic disturbance having a pattern repeating at 300 Hz. The repeated disturbance pattern also reveals the presence of harmonics at frequencies of 600, 1200 and 1500 Hz. The disturbance is identified to originate from electrical equipment used during the casting process, for instance a DC drive for an EM mold stirrer. Indeed, such a DC drive for the EM mold stirrer comprises a Graetz bridge for transforming three phase 50 Hz AC input power into DC output power. This DC power is not continuous but occurs at a base frequency of 300 Hz, corresponding to six DC pulses produced per 50 Hz AC cycle. As a result, an electromagnetic sensor located in close geometry with the EM mold stirrer will suffer from a 300 Hz electromagnetic disturbance pattern, which includes higher harmonics.

If for example a typical frequency in a range between 1200 Hz and 1500 Hz is used for powering the excitation coil of the electromagnetic sensor, especially the higher harmonics at 1200 Hz and 1500 Hz of the disturbance pattern will be detrimental for detecting small magnetic field variations with high accuracy.

With reference to FIG. 1, the detection problem encountered with electromagnetic sensors used for monitoring and/or controlling liquid metal during metal-making processes, is schematically illustrated. The electromagnetic sensor is operated in a batch mode wherein the excitation coil is repetitively energized and deenergized at a batch frequency f_{B}. Hence the response signals of the sensor are only present during the energizing time periods of the excitation coil. In the top panel of FIG. 1, an example of an undisturbed response signal S_{U} that is present when the excitation coil is excited is shown. In the middle panel, the observed electromagnetic disturbance EM_{DIS} is shown having repetitive disturbance patterns repeating at 300 Hz. This electromagnetic disturbance EM_{DIS}, is, as mentioned above, caused by external equipment such as an EM stirrer driver supplied by a three phase power supply, and hence the disturbance EM_{DIS} is continuously present, also while the excitation coil is turned off. Throughout the present disclosure, the disturbance pattern repeating at 300 Hz is also named disturbance signal DIS. As schematically shown on FIG. 1, per AC cycle period PAC of the three phase power supply powering the EM stirrer driver, there are six disturbance patterns DIS, namely two disturbance patterns DIS per phase voltage pair V1-V2, V2-V3 and V3-V1 of the three phase power supply. In the bottom panel the sum of the undisturbed repetitive signal S_{U} together with the electromagnetic disturbance EM_{DIS} is shown, corresponding to the total signal that is present when repetitively switching on and off the excitation coil. As illustrated in the bottom panel of FIG. 1, when data acquisition is performed in a batch mode, the total signals S_{U}+EM_{DIS} detected during the three subsequent acquisition time windows AW of each batch cycle are different from batch cycle to batch cycle. This is because the batch period P_{B}, defining the delay time between the start of two acquisition time windows AW, is not necessary a multiple of the disturbance period Pois. Hence, the starts of the acquisition time windows are not in phase with the disturbance signal DIS. These differences in disturbances from batch cycle to batch cycle cannot be corrected for and hence the accuracy of the electromagnetic sensor is reduced.

To solve this problem, the inventors have provided a novel detection system that is configured for adequately taking into account the repetition and phase of the disturbance signal.

The present invention is defined in the appended independent claim. The dependent claims define advantageous embodiments.

The detection system according to the present disclosure is characterized in that that it comprises a synchronization circuit comprising an input terminal for receiving one or more AC phase voltages from a three-phase power supply, and wherein the synchronization circuit is configured for outputting a pulse train having a pulse train frequency f_{P} with f_{P}=M×f_{AC} and wherein M is an integer number with M≥1, and wherein f_{AC} is a frequency of an AC cycle associated to the one or more AC phase voltages.

The detection system according to the present disclosure is further characterized in that it comprises a controller configured for controlling the electromagnetic sensor in a batch mode comprising consecutive batch cycles, and wherein each batch cycle comprises a first time window during which the excitation coil is energized and acquisition of the one or more response signals is performed, and one or more second time windows during which the excitation coil is deenergized. The controller is further configured for receiving the pulse train from the synchronization circuit and for starting the first time windows by, for each batch cycle, selecting a pulse from the pulse train and triggering a start of the AC current unit with the pulse selected.

Advantageously, by providing a synchronization circuit that is configured for outputting a pulse train having a pulse train frequency equal or a multiple of the frequency of the AC cycle of the three-phase power supply, used for instance by a driver of an EM mold stirrer, the energizing of the excitation coil can be triggered with selected pulses from the pulse train, i.e. energizing of the excitation coil will occur at a moment in time that is defined by a pulse of the pulse train. In this way, the time intervals between starts of consecutive first time windows are determined by time intervals between the selected pulses having triggered the energizing of the excitation coil. In other words, the time intervals between starts of the first time windows are for instance not determined by the internal clock of the microprocessor of the data acquisition system, as in the case in conventional data acquisition systems.

By using selected pulses from the pulse train to start energizing the excitation coil, the start of the first time windows will always occur at the same phase of the repetitive disturbance pattern. Indeed, the pulses of the pulse train specify a given phase of the disturbance pattern. As, for each batch, the first time window always starts at a same phase of the disturbance pattern, the disturbance pattern is disturbing the useful undisturbed signal always in the same way, i.e. it is a constant modification that is constant from batch to batch. This allows to better compensate or correct the signals detected. In this way, with the detection system according to the present disclosure, higher accuracies are obtained for detecting variations of a magnetic field caused by variations of eddy currents when compared to detection system not having a synchronization circuit and a controller as presently claimed.

### SHORT DESCRIPTION OF THE DRAWINGS

These and further aspects of the present disclosure will be explained in greater detail by way of example and with reference to the accompanying drawings in which:

FIG. 1 schematically illustrates a problem observed with electromagnetic sensors.

FIG. 2 schematically illustrates an example of a detection system according to the present disclosure,

FIG. 3 schematically illustrates an example of a detection system according to the present disclosure that is positioned in an exemplary metal-making plant having a continuous caster mold and an EM mold stirrer,

FIG. 4 schematically illustrates the principle of a batch mode acquisition performed with an embodiment of a detection system according to the present disclosure,

FIG. 5 schematically illustrates building blocks of a controller for controlling the electromagnetic sensor according to the present disclosure,

FIG. 6 to FIG. 8 schematically illustrate the principle of a batch mode acquisition performed with alternative embodiments of a detection system according to the present disclosure,

FIG. 9 schematically illustrates an exemplary embodiment of a synchronization circuit for outputting a pulse train from AC phase voltages,

FIG. 10 shows various voltage signals as function of time with respect to the synchronization circuit shown on FIG. 9.

The drawings of the figures are neither drawn to scale nor proportioned. Generally, identical components are denoted by the same reference numerals in the figures.

### DETAILED DESCRIPTION OF EMBODIMENTS

### Detection System

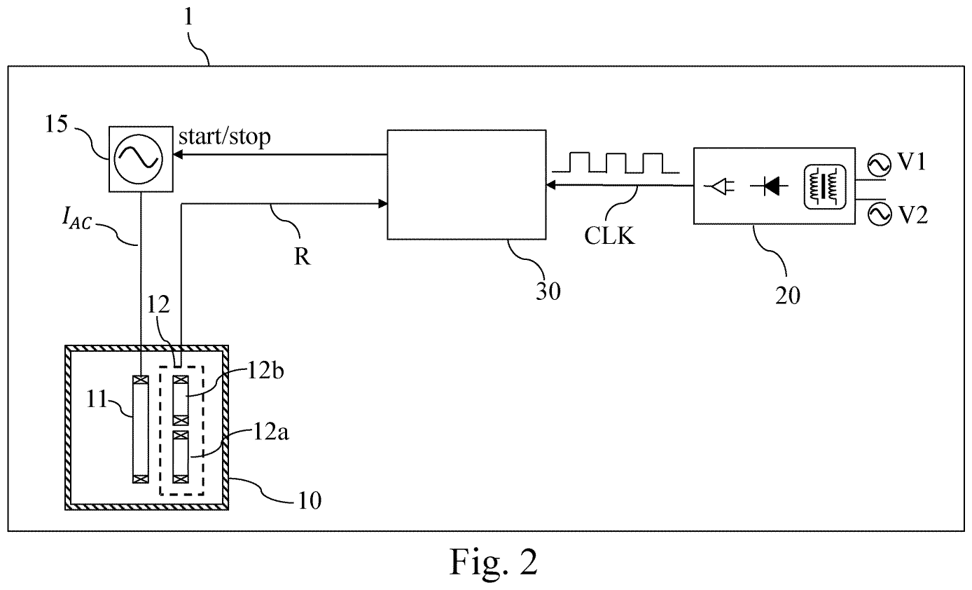

According to the present disclosure, a detecting system 1 for monitoring and/or controlling liquid metal during a metal-making process is provided. With reference to FIG. 2, an example of an embodiment of a detection system 1 according to the present disclosure is schematically shown to illustrate the major building blocks. The major building blocks of the detection system 1 are an electromagnetic sensor 10 having an excitation coil 11 and a receiver, an AC current unit 15 for energizing the excitation coil 11, a synchronization circuit 20 configured for outputting a pulse train and a controller 30 for controlling the AC current unit and for acquiring one or more response signals from the receiver. Various embodiment of these building blocks of the detection system according to the present disclosure will be discussed in detail here below.

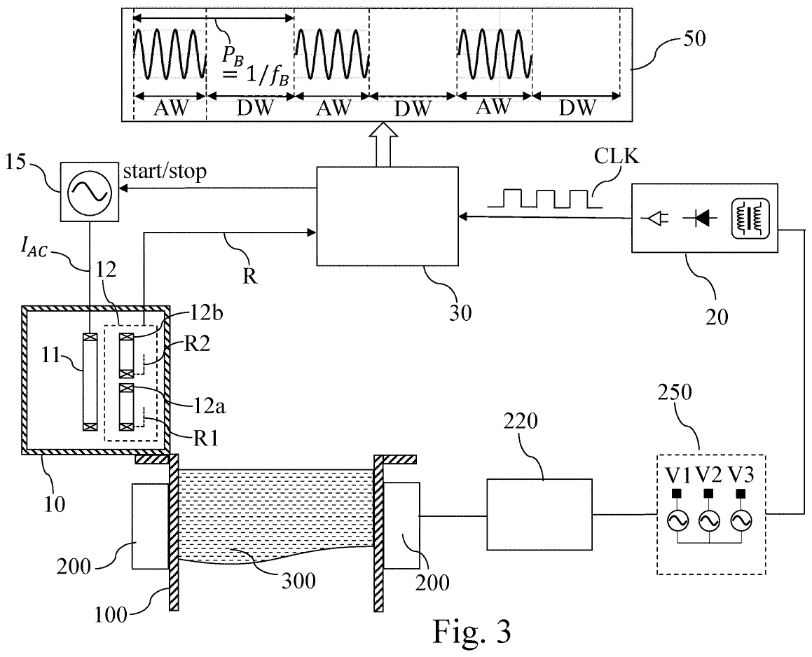

To better illustrate the working principle of the detection system 1, part of a continuous metal casting system is shown in FIG. 3, wherein the casting system comprises a continuous caster mold 100 for receiving liquid metal 300, an EM mold stirrer 200 coupled to the mold 100, an EM stirrer driver 220 for driving the EM mold stirrer and a three-phase power supply 250 for powering the driver 220.

The three phase power supply 250 has for example phase voltages V1, V2 and V3 as schematically illustrated on FIG. 3. In this example, the electromagnetic sensor 10 of the detection system is positioned in a periphery around the exemplary mold 100. The one or more response signals of the receiver of the electromagnetic sensor allow to determine a level of the liquid metal 300 in the continuous caster mold 100. Indeed, as depending on the level of the liquid metal in the mold, the distance between the electromagnetic sensor and the liquid metal varies and hence the eddy currents produced in the liquid metal will vary with the level of the metal in the mold.

In embodiments, the EM stirrer driver 220 is a DC driver. In other embodiments, the EM stirrer driver 220 is an AC driver.

The present disclosure is not limited to a specific type of electromagnetic sensor. What the electromagnetic sensors 10 according to the present disclosure have in common is that they comprise an excitation coil 11 for generating a magnetic field interacting with the liquid metal being processed, and a receiver 12 configured for receiving one or more response signals revealing a variation of the magnetic field caused by eddy currents induced in the liquid metal. As discussed above, the eddy currents induce an opposing magnetic field and hence vary the magnetic field.

In embodiments, the receiver 12 comprises a receiving coil 12a wherein a variation of the magnetic field observed by the receiving coil causes a variation of a voltage induced in the receiving coil 12a. Hence, the response signals have generally to be construed as voltage signals.

The excitation coil 11 is powered by an AC current unit 15 configured for supplying an AC current. In embodiments, an alternating current in a frequency range between 400 to 1600 Hz is provided. In embodiments, the AC current is for example 4 A. The AC current unit 15 comprises an interface for receiving start and stop trigger signals for respectively starting and stopping energizing the excitation coil. This allows the controller 30 to operate the electromagnetic sensor 10 in a batch mode as will be discussed below in more detail. A general advantage of using a batch mode of operation is that it helps to avoid that the excitation coil of the electromagnetic sensor would heat up too much.

In embodiments, electromagnetic sensors are used wherein the frequency of the AC current to power the excitation coil is much higher and is in a range of for example 5 kHz to 50 kHz.

An example an electromagnetic sensor for measuring a level of liquid metal in a continuous caster mold during continuous casting is described in U.S. Pat. No. 8,714,234B2, and this electromagnetic sensor is also schematically shown on FIG. 2. In this embodiment, the receiver 12 comprises a first receiving coil 12a and a second receiving coil 12b superposed on the first receiving coil. The first and second receiving coils are receiving respectively first R1 and second R2 response signals. In the configuration shown on FIG. 3, the first and second receiving coils can also be named lower and upper receiving coil, respectively. The lower receiving coil is positioned closer to the surface of the metal in the mold when compared to the upper receiving coil. In this way, due to the difference in position of the first and second receiving coil with respect to the metal in the mold, induced voltages in the upper and lower coils are different and this difference allows to determine for instance a level of liquid metal in the mold.

In embodiments wherein the receiver 12 comprises a first 12a and a second 12b receiving coil, the first 12a and second 12b receiving coil are electrical coupled within the receiver 12 for forming a single response signal R indicative of a difference in magnetic field as observed by the two receiving coils. In these embodiments, the single response signal R is then received by the controller 30.

In other embodiments wherein the receiver 12 comprises a first 12a and a second 12b receiving coil, the respective first and second response signals R1 and R2 are both received and processed by the controller 30 for revealing a variation in magnetic field caused by the eddy currents in the liquid metal.

In embodiments, the receiver 12 does not comprise a receiver coil but instead comprises for example an electronic circuit configured to detect a voltage of the excitation coil 11. In these embodiments, this voltage of the excitation coil is forming the response signal R. Indeed, as discussed above, the eddy currents generated a secondary magnetic field that varies the primary magnetic field, and hence also the voltage of the excitation coil will be modified by the eddy currents.

In embodiments, the electromagnetic sensor 10 comprises multiple receivers wherein each of the receivers comprises at least one receiving coil. These multiple receiving coils are for example positioned at different locations with respect to the continuous caster mold.

The embodiment of the electromagnetic sensor that is schematically shown in FIG. 3, is a so-called ledge sensor, which is a sensor that is positioned at an outer periphery of the continuous caster mold, generally near a rim of the mold. In other embodiments, the electromagnetic sensor is a so-called suspended sensor, wherein the sensor is positioned above the liquid metal. Generally, the suspended sensors have excitation coils that can operate at the higher frequencies of 5 kHz and more, mentioned above.

As schematically illustrated on FIG. 2, the detection system according to the present disclosure further comprises a synchronization circuit 20 comprising an input terminal for receiving one or more AC phase voltages V1, V2 from a three-phase power supply, e.g. having a 50 Hz or a 60 Hz AC cycle frequency. The synchronization circuit 20 is configured for outputting a pulse train CLK having a pulse train frequency f_{P} with f_{P}=M×f_{AC} and wherein M is an integer number with M 1, and wherein f_{AC} is a frequency of the AC cycle associated to the one or more phase voltages received from the three-phase power supply.

In embodiments, the pulse train CLK is a sequence of rectangular pulses or block pulses. As will be discussed below in more detail, the pulse train is used for controlling the timing for energizing the excitation coil 11 and for starting the acquisition of the response data obtained with the electromagnetic sensor.

As the pulse train has a frequency equal to or a multiple of the frequency of the AC cycle associated to the one or more AC phase voltages V1, V2, V3, one or more pulses are outputted per AC cycle, and each of the pulses outputted per AC cycle define a phase of the AC cycle. Preferably more than one pulse is outputted per AC cycle. If two pulses are outputted per AC cycle, for example a 100 Hz pulse train for a 50 Hz AC cycle or a 120 Hz pulse train for a 60 Hz AC cycle, the two pulses are separated in phase by 180°. A rising edge of a first pulse and a second pulse can for example specify respectively a 60° phase and a 240° phase with respect to the first AC voltage V1 of the three-phase power supply. Or alternatively a falling edge of the first and second pulse can for example define a phase of respectively 180° and 0°.

The frequency of the pulse train has to be construed as a fixed frequency. As the pulse train has a fixed frequency equal to or a multiple of the frequency of the AC cycle, the pulses outputted per AC cycle specify phases of the AC cycle that are the same as those specified by pulses outputted during subsequent AC cycles.

In embodiments, the pulse train CLK comprises pulses specifying for example a 0° and/or 180° phase with respect to an AC cycle of a phase voltage V1, V2, V3 received. In other embodiments, the pulses of the pulse train specify phases different from 0° and different from 180°. In other words, and as further outlined below, the exact value of the phases specified by the pulse train is less important. What is important is that the pulse frequency is equal to or a multiple of the AC cycle frequency such that the pulses observed within subsequent AC cycles specify the same phases of the AC cycle.

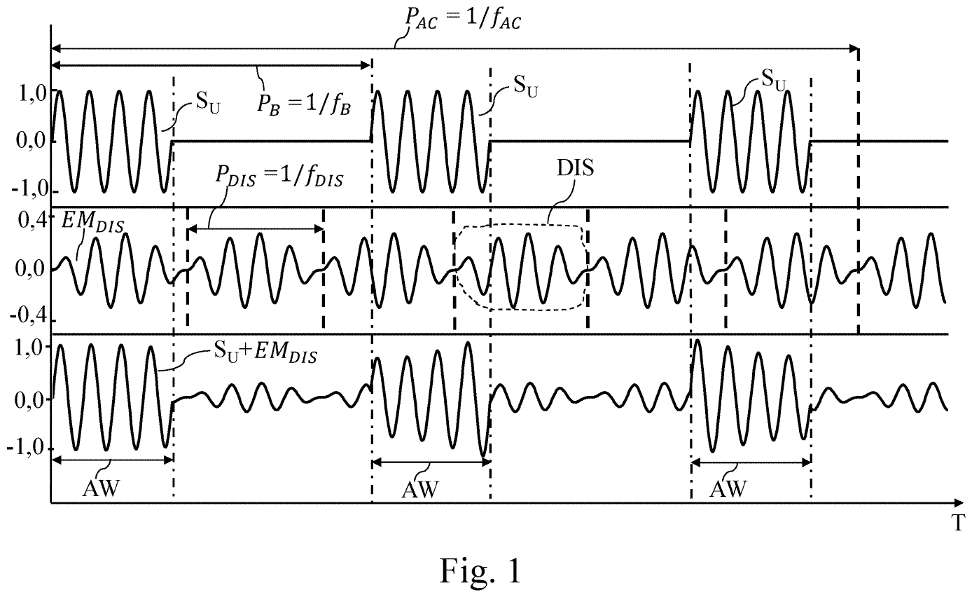

As the electromagnetic disturbance EM_{DIS}, shown for example in the middle panel of FIG. 1, is correlated with the AC cycle frequency associated to the phase voltages, more precisely the disturbance signal DIS is a signal repeated at a frequency equal to 6 times the AC cycle frequency, the phases specified by the pulses of the pulse train also specify starting points or phases of the disturbance signals.

The detection system 1 according to the present disclosure comprises a controller 30 configured for controlling the electromagnetic sensor 10 in a batch mode comprising consecutive batch cycles. Each batch cycle comprises a first time window AW during which the excitation coil 11 is energized and acquisition of the one or more response signals R, R1, R2 is performed, and one or more second time windows DW during which the excitation coil 11 is deenergized.

The first time windows AW can also be named acquisition time windows as acquisition of data is, by definition, performed when the electromagnetic sensor is ON, i.e. when the excitation coil is energized. Both wording, first time window and acquisition time window, will be used interchangeably throughout the description. The second time windows DW can also be named delay time windows.

Energizing the excitation coil 11 has to be construed as sending an AC current through the excitation coil in order to generate a varying magnetic field. Deenergizing the excitation coil has to be construed as stopping sending the AC current through the excitation coil such that the excitation coil no longer generates a magnetic field.

With reference to reference number 50 in FIG. 3, the operation in batch mode at a batch frequency f_{B} is schematically represented. In this example three batch cycles are shown and each batch cycle period P_{B} comprises a first time window AW and a second time window DW.

During first time windows AW wherein the excitation coil is energized, the response signal from the electromagnetic sensor together with the disturbance signal is acquired.

In embodiments, during the second time windows DW, the acquisition of data is stopped. In general, the second time windows DW are used for data processing and/or reading out data.

In embodiments, per batch cycle, multiple delay time windows DW during which the excitation coil is deenergized can be used for different purposes. For example a first delay time window DW can be used for data processing of the acquired data, a second delay time window DW can be used for acquiring the disturbance signal and a third delay time window can be used for processing the disturbance signal.

The controller 30 according to the present disclosure is further configured for starting the first time windows AW by performing for each batch cycle steps of: selecting a pulse from the pulse train CLK and triggering a start of the AC current unit 15 with the pulse selected. As a result of the triggering of the start of the AC current unit 15, the excitation coil becomes energized.

Hence, for each batch cycle, one pulse of the pulse train is to be selected for triggering the start of the AC current unit. By performing the batch operation in this way, the first time windows AW are always triggered by a pulse of the pulse train and, for each batch cycle, the acquisition time windows AW starts in phase with the disturbance signal. In other words, the start of first time windows is not determined for instance by an internal clock of the controller, as is usually the case with conventional data acquisition systems, but instead the first time windows are triggered by a pulse train outputted by a dedicated synchronization circuit.

Advantageously, by performing, for each acquisition time window, the triggering of the AC current unit with a pulse of the pulse train, the disturbance signal or part of the disturbance signal observed during the acquisition time window is the same for each subsequent acquisition time window, which facilitates to correct the acquired signal for the repetitive disturbance signal. This is of importance, especially when the excitation coil operates in a frequency range between 400 to 1500 kHz, i.e. in a frequency range wherein harmonics of the disturbance signal occur, and hence wherein filtering out the disturbance signal becomes very difficult. But also electromagnetic sensors having excitation coils operating in a higher frequency range, e.g. above 5 kHz as mentioned above, take advantage from the present control technique for reducing the deleterious impact of EM disturbances.

In embodiments, the controller 30 is configured for triggering a start signal for starting the acquisition of the one or more response signals R, R1, R2, and this triggering of the start signal for starting the acquisition is synchronized with the triggering of the start of the AC current unit 15 for starting energizing the excitation coil 11.

In embodiments, there can however be a fixed delay between the triggering of the start signal for starting the acquisition of the one or more response signals and the effective start of the acquisition. This allows for instance the electromagnetic sensor to be stabilized before effectively starting with the acquisition. But as this delay is constant, the effective start of the acquisition will always, for each batch cycle, start at a same phase of the disturbance signal.

In embodiments, a duration of the first time windows AW is specified by a pre-defined time period and the controller 30 comprises an internal clock for controlling when the pre-defined time period has lapsed.

In embodiments, the controller 30 is further configured for stopping the first time windows AW by performing for each batch cycle steps of: monitoring a time lapse since the start of the first time window AW, and if the pre-defined time period has lapsed then triggering a stop of the AC current unit 15 so as to stop energizing the excitation coil.

In embodiments, this pre-defined time period can be a configurable value. The value can be a parameter stored in a memory of the controller.

The pre-defined time period defining the duration of the first time windows is generally specified as being equal to K×1/f_{C} wherein K is an integer number with K≥1, preferably K≥2, more preferably K≥3, and wherein f_{C} corresponds to an AC excitation frequency for energizing the excitation coil 11. In other words, the pre-defined value is specified to cover a number of AC cycles powering the excitation coil.

In embodiments, the controller 30 is configured for triggering a stop signal for stopping the acquisition of the one or more response signals. This triggering of the stop signal for stopping acquisition is synchronized with the triggering of the stop of the AC unit. In this way, no unnecessary background signals are continued to be acquired after deenergizing the excitation coil.

As discussed above, per batch cycle one pulse of the pulse train is selected to trigger a start of the AC current unit. What pulses are to be selected from the pulse train to trigger the energizing of the excitation coil depends on the batch frequency f_{B}. Indeed, if for example the pulse frequency of the pulse train is higher than the batch frequency then multiple pulses occur within a batch period, and therefore for each batch cycle some pulses of the pulse train are to be skipped as for starting the acquisition time windows for acquiring the one or more response signals only one pulse per batch cycle is required. What the batch frequency actually is, depends on the detailed implementation of the detection system, such as for example the speed of the CPU of the controller, which determines how much time is to be kept in between two first time windows. Various embodiments on how the pulses are selected will be discussed below when discussing detailed embodiments of the controller.

Detailed embodiments of two important components of the electromagnetic detecting system according to the present disclosure, namely the controller and the synchronization circuit, are further discussed.

### Embodiments of Controllers Operating at a Fixed Batch Frequency

Two major type of categories of embodiments of controllers according to the present disclosure can be distinguished. The difference between the two categories is related to the way pulses from the pulse train are selected for using them to trigger the energizing of the excitation coil.

A first category of controllers are configured for controlling the electromagnetic sensor 10 in a batch mode wherein the batch cycles are repeated at a fixed batch frequency. A fixed batch frequency implies that the batch frequency remains constant during operation of the detection system.

In these embodiments of the first category, the step performed by the controller of selecting, for each batch cycle, a pulse from the pulse train CLK comprises sub steps of: detecting a firstly arriving pulse since a start of a new batch cycle and selecting the firstly arriving pulse for triggering the start of the AC current unit. A firstly arriving pulse has to be construed as the pulse that comes first in time since the start of a new batch cycle.

In some embodiments of the first category, the fixed batch frequency is controlled independently from the frequency of the pulse train CLK. In embodiments the controller comprises for example a microcontroller that controls the batch frequency at a fixed pre-determined value independently of the control of the frequency of the pulse train, which is controlled by the synchronization circuit.

In the embodiments of the first category, the batch frequency is controlled by for example an internal clock of the controller. In embodiments the batch frequency can be a configurable value. A batch frequency can for example be set to 33.0 Hz, 50.0 Hz, 66.66 Hz or any other selected value. What frequency can be used will strongly depend on the time needed to process the data in between two consecutive acquisition time windows and hence strongly depends on the type of microprocessor used for the data acquisition.

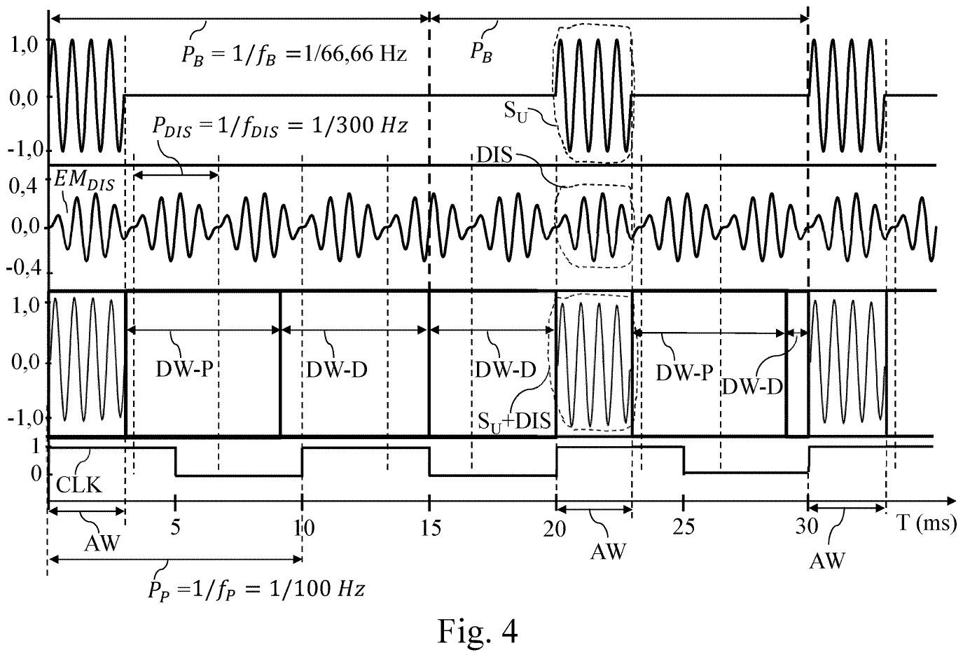

With reference to FIG. 4, operation in batch mode with an embodiment of a controller 30 according to the first category is further discussed. In this example shown on FIG. 4, the batch cycle is performed at a batch frequency f_{B} of 66.66 Hz corresponding to a batch period P_{B} of 15 ms. The top panel illustrates the undisturbed signal S_{U} that is present each time the excitation coil is energized. The panel below the undisturbed signal shows the electromagnetic disturbance EM_{DIS} which as discussed above is present all the time. The electromagnetic disturbance DIS is however presenting a repetitive pattern, named disturbance signal DIS, which in this example is repeated at 300 Hz. As previously discussed, this corresponds to a disturbance expected from for example a DC driver of an EM stirrer that is powered with a 50 Hz three-phase power supply. If the power supply would be a 60 Hz supply then the disturbance signal would be repeated at 360 Hz. In the panel below the electromagnetic disturbance EM_{DIS}, the signals from the receiver of electromagnetic sensor as acquired with the controller 30 are shown. The acquired signal S_{U}+DIS is a sum of the undisturbed signal S_{U} and at least part of the disturbance signal DIS. Remark that the period AW of the acquisition time window is generally not equal to the period Pois of the disturbance signal, and hence generally only a part of the disturbance signal DIS is acquired during the acquisition time window AW. When the reference indication S_{U}+DIS is used on the figures for indicating the acquired signal during the acquisition time window AW, it has to be construed as the sum of the undisturbed signal S_{U} with the corresponding part of the disturbance signal DIS as observed in the time window AW.

The bottom panel of FIG. 4 shows the pulse train CLK, which, in this example, has a pulse frequency f_{P} of 100 Hz. The acquired signal S_{U}+DIS is acquired during the first time window AW of each batch cycle. As mentioned above, the first time windows AW are the time windows wherein the excitation coil is energized and data acquisition of the response signal is performed. As shown on FIG. 4, the acquisition time windows AW have a start that is triggered with a selected pulse of the pulse train. In this example, the triggering is based on the rising edge of the pulse of the pulse train.

The selection of the pulses of the pulse train that trigger the start of the first time windows AW, using a controller of the first category, is further discussed. With reference to FIG. 4, for the first batch cycle shown, the first time window was for example starting at time zero and the first time window is stopped after a number of excitation cycles of the excitation coil, in this example after four excitation cycles. The excitation frequency for the excitation coil was in this example 1350 Hz resulting in a first time window AW having a time period of 2.96 ms. The first time window AW is followed by a second time window DW-P wherein the acquired data during the first time window AW are processed. This processing time window DW-P is a fixed time period defined by the processing time needed to process the data. In this example, the time window DW-P for processing the acquired signals is set to about 6 ms. In order to complete the batch period P_{B} of 15 ms, a further delay time window DW-D of about 6 ms is required. Remark that with the controller 30 according to the first category the batch cycle has a fixed period P_{B}, and in this example although at a time of 10 ms, a new cycle of the repetitive disturbance pattern DIS starts, a new acquisition time window AW cannot be started in view of the fixed batch period of 15 ms. When the first batch cycle is completed, a second batch cycle starts and the controller 30 will continue monitoring the pulse train CLK and select the pulse that is received firstly since the start of the second batch. In this example, before this first pulse has arrived, a period, in this example of 5 ms, has elapsed and hence the second batch cycle starts with a delay time window DW-D of 5 ms. Following the rising edge of the first pulse arrived since the start of the second batch cycle, the first time window AW for data acquisition starts again for a time period of 2.96 ms. Thereafter, the response signal acquired during the first time window AW of the second batch cycle is processed during time window DW-P of the second batch cycle, which takes again about 6 ms. To complete the second batch cycle exactly at 15 ms, a further delay time window DW-D of about 1 ms is required. After completion of the second batch cycle, the third batch cycle starts. In this example, the third batch cycle starts immediately with a first time window AW for acquisition of response data as there is a pulse from the pulse train just arriving at the moment of the start of the third batch, i.e. at 30 ms.

As illustrated on FIG. 4, as a consequence of the steps performed by the controller for starting the first time windows AW, i.e. starting energizing the excitation coil and starting data acquisition, each of the three time windows AW for data acquisition start in phase with the disturbance signal DIS, i.e. the disturbance signal of the part of the disturbance signal that is present during the acquisition time windows AW is the same for each batch cycle.

As a consequence of the pulse selection mechanism discussed above, for embodiments of controllers 30 of the first category, the pre-defined batch frequency f_{B} has to be selected to be lower than the frequency f_{P} of the pulse train. What batch frequency is to be used in relation to pulse frequency is to be determined in function of the required duration for the second time windows to perform for instance data processing.

A further consequence for controllers of the first category that are operating at a fixed pre-defined batch frequency and applying the pulse selection mechanism discussed above, is that the time intervals between the starts of two consecutive first time windows are not necessarily constant, but are defined by time intervals between selected pulses of the pulse train. For example, as schematically illustrated on FIG. 4, the time interval between the start of the first and the second acquisition time window AW is 20 ms and the time interval between the start of the second and third acquisition time window AW is 10 ms. Where exactly the first windows fall within a batch period is not important for what concerns the data read/out and data processing as there is sufficient time during the batch period to perform the data processing. What is important is that for each batch cycle the start of the first time windows AW are triggered by pulses of the pulse train, such that each of first time window starts at a same phase of the disturbance signal.

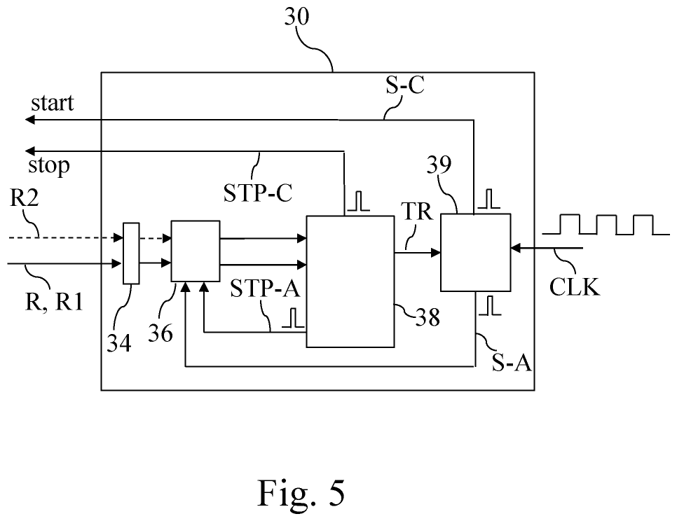

With reference to FIG. 5, an exemplary embodiment of a controller 30 is schematically shown. In this example, the controller 30 comprises a signal conditioning unit 34 for initially shaping the one or more response signals, an analogue to digital converter ADC 36, a microcontroller 38 and a trigger control unit 39 configured for receiving the pulses from the pulse train and for controlling a selection of the pulses of the pulse train to be used to trigger the excitation coil. The optional signal conditioning unit 34 is used for shaping the response signals to be ready to be received by the ADC, typically, the signal conditioning unit comprises a signal amplifier.

The embodiment of the controller 30 shown in FIG. 5 is either configured for receiving one response signal R from the receiver 12, wherein as discussed above, the signal R reveals a variation of the magnetic field caused by eddy currents in the liquid metal.

In other embodiments as also discussed above, the receiver 12 outputs two response signals R1 and R2 and the combination of the two signals reveal the variation of the magnetic field caused by the eddy currents. For these embodiments, the controller is configured for receiving the two response signals R1 and R2. This is schematically shown on FIG. 5, with the dotted arrow indicating embodiments having a second input for receiving, besides the first response signal R1, also receiving the second response signal R2.

In embodiments wherein the controller receives two response signals R1 and R2, the controller comprises for example two ADC's and acquisition of both signals R1 and R2 is performed during the first time windows AW, as discussed above.

In this embodiment shown on FIG. 5, the trigger control unit 39 will generate a first trigger signal S-C from the selected pulse from the pulse train and send the first trigger signal S-C to the AC current unit 15 for starting energizing the excitation coil.

When a pre-defined time has lapsed since the start of the first time windows AW, i.e. since triggering the start of the AC current unit for energizing the excitation coil, the microcontroller 38 will generate a second trigger signal STP-C and sending the second trigger signal STP-C to the AC current unit 15 for stopping energizing the excitation coil.

As further illustrated on FIG. 5, the acquisition of the response data is started in synchrony with the energizing of the excitation coil by sending a trigger signal S-A to the ADC 36 to start sampling data. When the pre-defined time for data acquisition has lapsed, the microcontroller sends a trigger signal STP-A to the ADC 36 to stop sampling data.

The microcontroller 38 can for example be a DSP, digital signal processor, which is a specialized form of a microcontroller. The architecture and configuration of a DSP are generally optimized for real-time digital signal processing. Typically, DSP's incorporate onboard volatile and nonvolatile memory and provide for a range of peripheral interfaces.

In the embodiment shown on FIG. 5, the controller 30 is of the first category as discussed above and a microcontroller 38 controls the batch frequency. In this example, when a batch period is completed and a new batch period starts, the microcontroller 38 sends a trigger request signal TR to the trigger control unit 39 requesting to select the first pulse of the pulse train following the request. The trigger control unit 39 receiving the pulse train CLK then selects the firstly receiving pulse of the pulse train following reception of the request signal TR. This firstly receiving pulse is selected as the pulse to be used for energizing the excitation coil.

Typically, each pulse of the pulse train CLK comprises a rising edge and a falling edge. In embodiments, the trigger control unit 39 comprises an edge detecting circuit for detecting the rising edge or the falling edge of the pulses selected.

For example, with the embodiment shown on FIG. 5, either based on a detected rising edge or based on a detected falling edge of the pulse selected, the trigger control unit will generate two start signals. A first start signal S-C for triggering the energizing of the excitation coil 11 with the AC current unit, and a second start signal S-A for starting the acquisition of the one or more response signals by triggering the ADC 36. In embodiments, a fixed delay line can be used to for example delay start signal S-A with respect to start signal S-C.

### Embodiments of Controllers Operating at a Batch Frequency Determined by the Pulse Train Frequency

A second category of controllers are not using a pre-defined batch frequency controlled by the internal clock of the controller as in the case with controllers of the first category.

For embodiments of the second category, the controller 30 is configured for repeating the batch cycles at a batch frequency f_{B} that is determined by a frequency f_{P} of the pulse train CLK, wherein f_{B}=f_{P}/N with N being an integer number and N≥1. The step performed by the controller of selecting a pulse from the pulse train CLK for each batch cycle is performed by selecting a pulse of the pulse train every N^{the} pulses.

Hence, for the embodiments of the second category, a batch period 1/f_{B} is defined as a time difference between N number of pulses and the batch mode is operating at a batch frequency f_{B}=f_{P}/N, with f_{P} being the pulse frequency of the pulse train CLK.

The value of the number N will depend on the processing speed of the controller, e.g. the time needed to process acquired data during the batch period, and on the pulse frequency of the pulse train. In preferred embodiments N≥2. This is preferably when working at pulse train frequencies of 100 Hz or more.

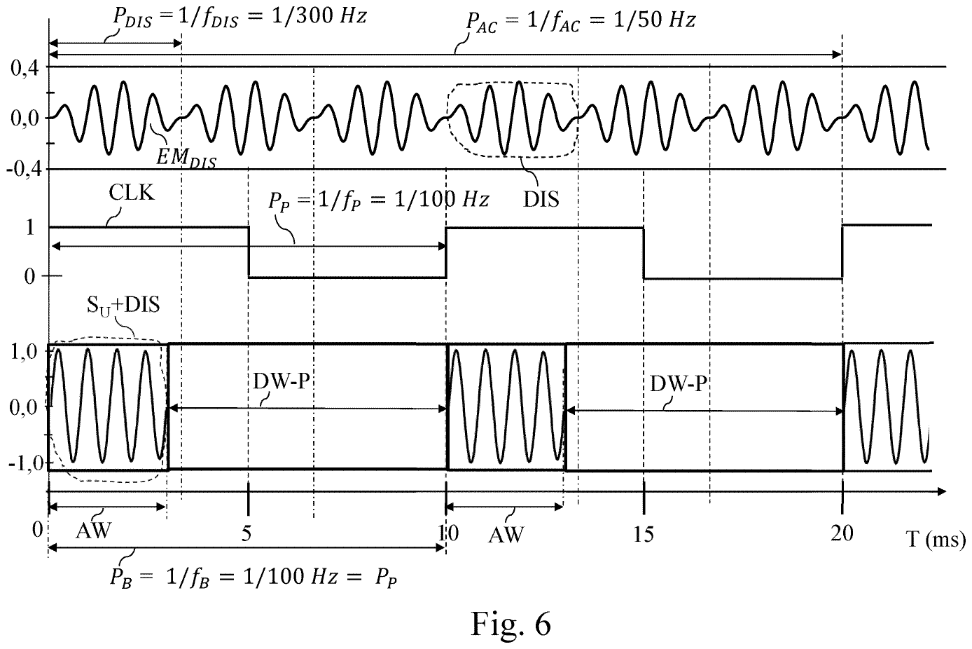

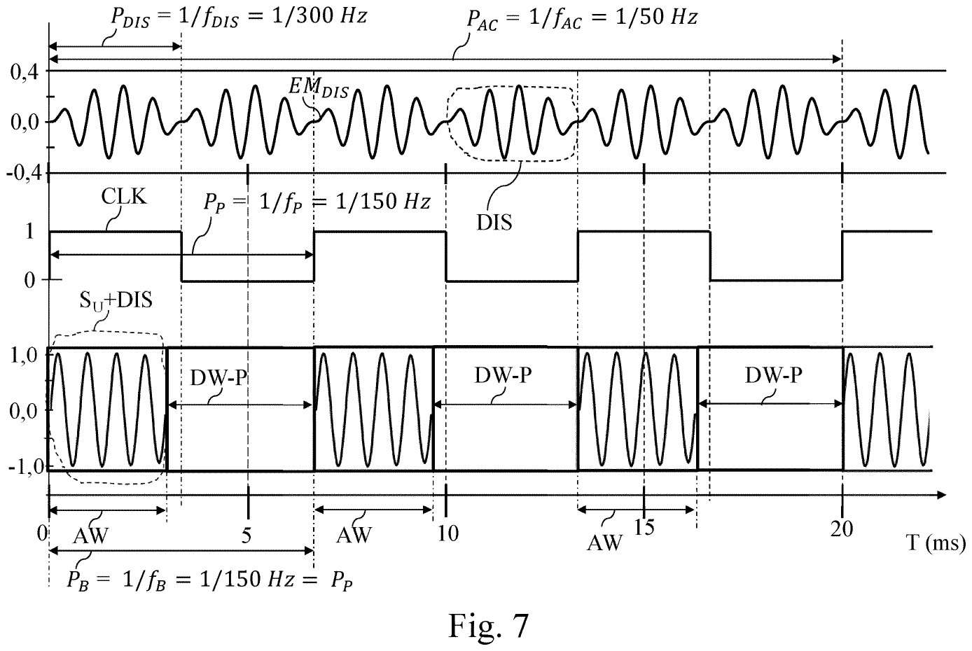

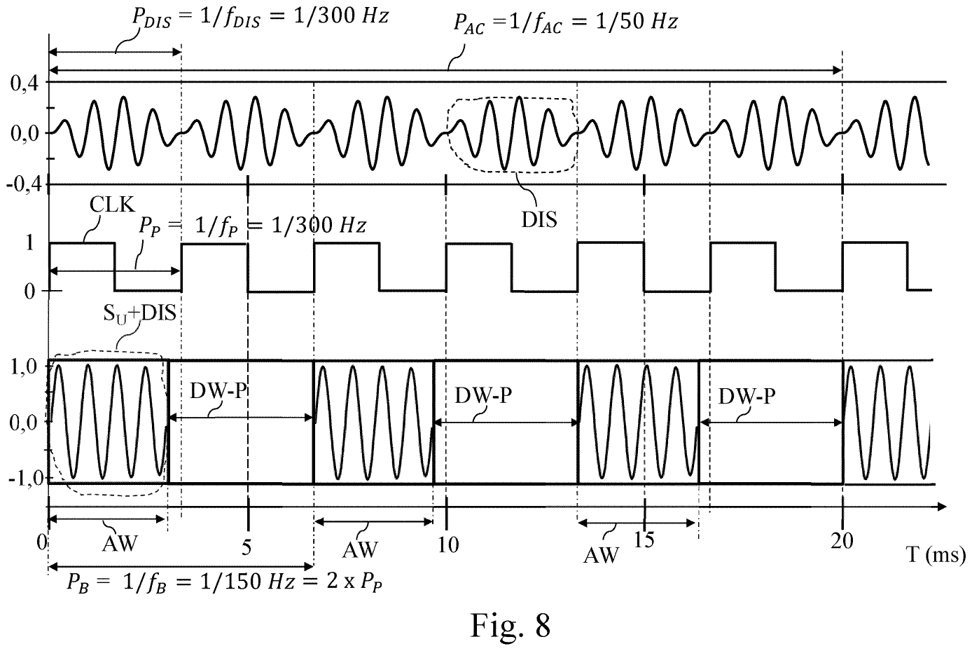

With reference to FIG. 6, FIG. 7 and FIG. 8, the operation of a controller of the second category according to the present disclosure, is further discussed. In the top panel the continuous electromagnetic disturbance EM_{DIS} is shown having a repetitive disturbance signal DIS, repeating at 300 Hz. In the middle panel the pulse train CLK is shown and in the lower panel the sum of the undisturbed response signal S_{U} with the disturbance signal DIS as acquired within the acquisition time window AW is shown. The difference between the three embodiments shown in FIG. 6, FIG. 7 and FIG. 8 is the clock frequency used for the pulse train which are respectively 100 Hz, 150 Hz and 300 Hz. As discussed above, in these embodiments of the second category, the batch period P_{B} is proportional to the period of the pulse train. In FIG. 6 and FIG. 7 an embodiment is shown wherein the batch frequency is equal to the frequency of the pulse train, while the embodiment shown in FIG. 8 has a batch period P_{B} that is double the pulse train period PP.

As a consequence of the steps performed for starting the first time windows AW for data acquisition by the controller of the second category, as discussed above, each of the time windows AW for data acquisition shown on FIG. 6 to FIG. 8 start in phase with the disturbance signal DIS.

Embodiments of a controller 30 according to the second category are similar to a controller of the first category shown for example on FIG. 5. However in embodiments of the second category, the microcontroller 38 is not sending a trigger request TR to the trigger control unit 39 when a batch cycle is completed. Instead, the trigger control unit 39 comprises an electronic circuit configured for selecting a pulse from the pulse train every N number of pulses. Following reception of every N^{tbe} pulse, the trigger control unit 39 is further configured for outputting the first trigger signal S-C for starting the AC current unit and outputting the second trigger signal S-A for starting the ADC 36 to start sampling response data.

### Acquisition of the Disturbance Signal, Embodiments

In some embodiments, as mentioned above, per batch cycle, there can be multiple delay time windows DW during which the excitation coil is deenergized and these multiple delay times can be used for different purposes.

For example a dedicated background delay time window can be used for acquiring the disturbance signal.

In these embodiments, for each batch cycle, the controller is configured for selecting a second pulse from the pulse train and triggering a start signal with this second pulse for starting acquisition of the disturbance signal during the dedicated background delay time window.

The duration of the dedicated background delay time window can be specified by a pre-defined time period, and which is preferably set equal to the period of the first time windows AW, or alternatively set equal to the period Pois of the disturbance signal. The controller is further configured to triggering a stop signal for stopping acquisition of the disturbance signal if the pre-defined time period has lapsed.

Following the acquisition of the disturbance signal, a further delay time window DW-P is provided for processing the acquired disturbance signal.

For controllers of the first category as discussed above, the controller will select this second pulse by selecting the firstly receiving pulse following completion of the data processing during the delay time window DW-P used for processing the acquired signals during the acquisition time window AW. In these embodiments wherein additionally a disturbance signal is acquired, the batch period P_{B} is selected to be longer when compared to embodiments wherein no disturbance signal is measured. The person skilled in the art will define the batch frequency by taking into account the various delay time windows necessary for acquisition and processing of both the response signal and the disturbance signal.

For controllers of the second category as discussed above, the controller is configured for selecting the second pulse for starting acquiring the disturbance signal by selecting a pulse received X number of pulses after having selected the pulse for starting the AC current unit. With X being an integer number equal or larger than one and X<N, with N being the integer number discussed above defining the batch frequency as being f_{B}=f_{P}/N.

The person skilled in the art will define values for X and N such that the batch period is long enough to comprise the various time windows for acquiring and processing the response signal and the disturbance signal.

Advantageously, by taking an acquisition of the disturbance signal, the disturbance signal can be subtracted from the response signal measured during the first time windows AW.

### Synchronization Circuits, Embodiments

Various embodiments of a synchronization circuit for generating a pulse train based on AC phase voltage inputs can be envisioned by a person skilled in the art. Such a synchronization circuit 20 comprises a voltage transformer 22 for stepping down the AC phase voltages to lower AC voltages and a rectifier circuit 24 coupled to the voltage transformer 22 and wherein the rectifier circuit is configured for rectifying AC currents and generating analogue voltage pulses synchronized with the AC cycle of the three phase power supply. The synchronization circuit 20 further comprise an output circuit 25 configured for generating a train of digital pulses in synchrony with the analogue voltage pulses generated by the rectifier circuit 24. This train of digital pulses is forming the pulse train CLK.

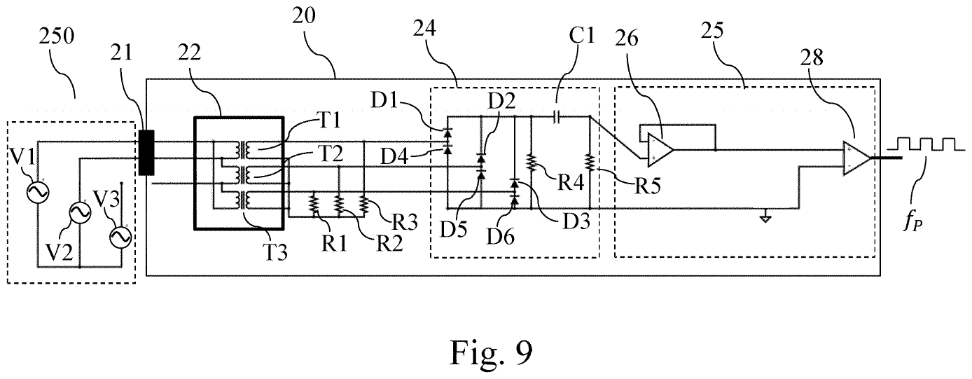

In the embodiment shown on FIG. 9, the synchronization circuit is configured for receiving two phase voltages V1 and V2 at its input. The synchronization circuit comprises a voltage transformer 22 having a set of three transformer coils T1, T2 and T3 which are coupled in a so-called delta-configuration. With the secondary windings of each of the transformer coils three closed loop circuits are formed with the respective resistors R1, R2 and R3. The rectifier circuit 24 shown in this example is a so-called three-phase bridge rectifier circuit for rectifying a current flowing through the three closed loop circuits. To rectify the currents the rectifier circuit 24 comprises an arrangement of six diodes D1 to D6 as illustrated on FIG. 9. The rectified current is forming closed loop circuits through resistor R4 and a capacitor C1 combined with resistor R5 allow to detect an output voltage. The output voltage is followed by a voltage follower 26 acting as an isolation buffer and finally the output voltage is transformed in block pulses through a comparator circuit 28. In the exemplary synchronization circuit 20 shown on FIG. 9, the values of the resistors R1, R2, R3, R4, R5 are respectively, 50Ω, 50Ω, 50Ω, 10 kΩ, 500 kΩ, and the capacitor C1 has a value of 100 nF.

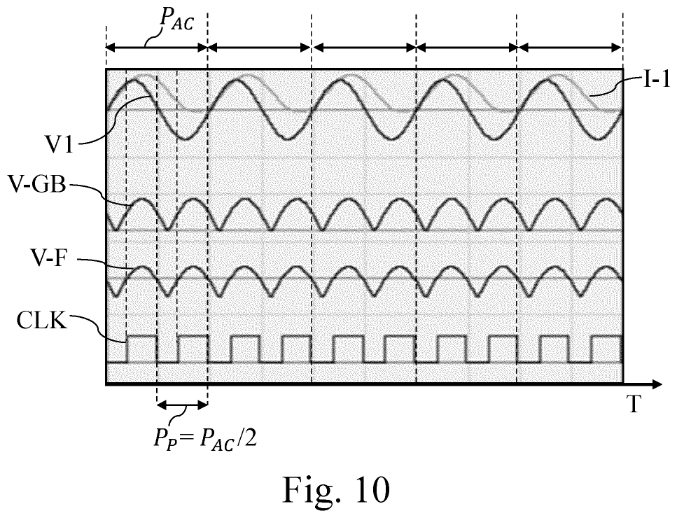

With reference to FIG. 10, various voltage signals are shown as function of time with respect to the embodiment of the synchronization circuit shown in FIG. 9. The top panel shows the voltage V1 being a first phase voltage received at the input terminal of the synchronization circuit and I-1 is the corresponding current flowing in the first voltage line. The second phase voltage V2 is not shown on FIG. 10, but the second phase voltage is a voltage shifted in phase by 120° with respect to the first phase voltage V1. The alternating voltage V1 is received at an AC cycle with period PAC. The voltage V-GB shown on FIG. 10, is an analogue voltage associated to the rectifier circuit and corresponds to the voltage observed across transistor R4 shown on FIG. 9. The voltage V-F is the analogue voltage signal measured at the output of the voltage follower 26 shown on FIG. 9. And finally the bottom panel shows the resulting clock signal CLK outputted by the comparator 28 shown on FIG. 9.

As a result, for the embodiment shown on FIG. 9 having two phase voltages at its input, the synchronization circuit outputs a pulse train having a frequency that is twice the frequency of the AC cycle of the three-phase power supply. For example for a power supply having an AC cycle of respectively 50 Hz or 60 Hz at the input, a 100 Hz pulse train or a 120 Hz pulse train is generated. With the embodiment shown on FIG. 9, the two pulses that are outputted per AC cycle specify a phase of the AC cycle. This is illustrated on FIG. 9, where the rising edge of the two pulses specify a 60° and 240° phase with respect to the phase voltage V1. And alternatively, the falling edge of the two pulses specify a phase of respectively 180° and 0° with respect to the phase voltage V1. These falling or rising edges can be used to accurately define the trigger signals for starting the AC current circuit for energizing the excitation coil.

In other embodiments the pulse train can be generated based on a single phase line combined with a ground line. The ground line can for instance be the ground line of a three phase power supply having a ground line.

In embodiments wherein the synchronization circuit receives only one phase voltage and the ground voltage as an input, the rectifier circuit of the synchronization circuit can be configured to for example only rectify the positive voltages, such that a pulse train having a frequency equal to the frequency of the AC cycle of the phase voltage is outputted, e.g. a 50 Hz or 60 Hz pulse train.

In further embodiments, the input terminal is configured for receiving the three phase lines of the three-phase power supply and the synchronization circuit is configured for outputting the pulse train based on the three phase voltages V1, V2 and V3. In this way, a pulse train at a frequency that is six times the frequency of the AC cycle is outputted. For instance a 300 Hz pulse train CLK can be outputted if the AC cycle frequency is 50 Hz, which is for example illustrated on FIG. 8.

In embodiments, the synchronization circuit comprises a voltage transformer 22 having a set of three transformer coils T1, T2 and T3 which are coupled in a so-called star-configuration. In these embodiments, the input terminal of the synchronization circuit is configured for receiving, besides one or more phase voltages, also receiving a neutral voltage or ground voltage. In such a star-configuration the three transformer coils T1, T2 and T3 of the voltage transformer 22 are connected through one of their ends to a common point which is connected to the neutral or ground voltage received at the input terminal of the synchronization circuit.

In embodiments, the synchronization circuit 20 comprises a phase shifter configured to shift the phase of the pulse train in relation to the phase of the AC cycle of the one or more phase voltages, i.e. in relation to the AC cycle of the three phase power supply supplying the one or more phase voltages.

As discussed above, the pulses of the pulse train specify not only a phase of the AC cycle of the one or more phase voltages but also specify a phase of the disturbance signal DIS. By using a phase shifter, the phase of the pulse train can be chosen such that rising edges of the pulses of the pulse train fall at the most opportune moment in time to start the first time windows AW, i.e. starting energizing the excitation coil 11 and starting acquisition. More precisely, the phase of the pulse train can be chosen such that the deformation of the undisturbed signal S_{U} by the disturbance signal DIS is minimized. The person skilled in the art will select what phase shift is required to minimize the effect of the disturbance signal on the undisturbed signal, for example by performing measurements with various phase shifts. Hence, by using a phase shifter, a rising edge of pulses of the pulse train does not necessary fall for example at a 0° phase of the disturbance signal DIS, as schematically illustrated for example by pulses shown on FIG. 4 and FIG. 6 to FIG. 8, but instead the rising edge of the pulses can fall at any phase selected by the phase shifter. The addition of such an optional phase shifting circuit is advantageous, especially if the frequency of the excitation coil 11 is near the frequency of one of the higher harmonics of the disturbance signal.

Hence, for embodiments wherein the synchronization circuit comprises a phase shifter, not only are the acquisition time windows AW starting at the same phase of the repetitive disturbance pattern for each batch cycle, as is the case for all embodiments of the present disclosure, but additionally, the deformation of the undisturbed signal by the disturbance signal is also minimized by adequately selecting a phase shift with the phase shifter.

Embodiments of synchronisation circuits comprising a phase shifter are similar to the synchronisation circuit shown on FIG. 9, except that the pulse train outputted by the circuit shown on FIG. 9, which can be named a first pulse train, is received by the phase shifter that outputs a second pulse train having a phase that is shifted with respect to the first pulse train. The second pulse train is then received by the controller 30. Phase shift circuits or delay line circuits for generating a phase shift are known in the art. The phase shifter is an electronic circuit comprising for example operational amplifiers configured for generating the phase shift.

Based on the teaching given above, a person skilled in the art can develop alternative embodiments of synchronisation circuits for outputting a pulse train based on one or more AC phase voltages received at its input.

Further, the person skilled in the art will design the synchronization circuit to output a pulse train at a preferred pulse train frequency f_{P}. To optimize the detection system, the frequency f_{P} of the pulse train can be specified in relation to the frequency of the disturbance pattern. For example, for a 50 Hz or 60 Hz three-phase power supply supplying power to an EM stirrer driver, the disturbance pattern is a pattern that repeats at a frequency of respectively 300 Hz and 360 Hz. The frequency of the pulse train can for example be selected such that each of the pulses of the pulse train define the same phase of the disturbance pattern. This facilitates the selection of pulses for triggering the energizing of the excitation coil. Therefore, preferably M is an integer number equal to any of: 1, 2, 3 or 6. By selecting the number M in this way, each of the pulses of the pulse train define the same phase of the disturbance pattern DIS.

In more preferred embodiments M=2. This corresponds for example to the embodiment discussed above with reference to FIG. 9. In this way, pulses of the pulse train not only define the same phase of the disturbance pattern but the pulses also only refer to a disturbance pattern associated to one pair of the AC phase voltages, e.g. V1-V2, of the three possible combinations of voltage pairs of the three-phase power supply. As there can be minor differences between disturbance patterns associated to each of the three pairs of phase voltages, V1-V2, V2-V3, V3-V1, selecting M=2, is an optimum value.

The present disclosure has been described in terms of specific embodiments, which are illustrative of the disclosure and not to be construed as limiting. It will be appreciated by persons skilled in the art that the present disclosure is not limited by what has been particularly shown and/or described and that alternatives or modified embodiments could be developed in the light of the overall teaching of this disclosure. The drawings described are only schematic and are non-limiting.

Use of the verb “to comprise”, as well as the respective conjugations, does not exclude the presence of elements other than those stated. Use of the article “a”, “an” or “the” preceding an element does not exclude the presence of a plurality of such elements.

Furthermore, the terms first, second and the like in the description and in the claims, are used for distinguishing between similar elements and not necessarily for describing a sequence, either temporally, spatially, in ranking or in any other manner.

Reference throughout this specification to “one embodiment” or “an embodiment” means that a particular feature, structure or characteristic described in connection with the embodiments is included in one or more embodiment of the present disclosure. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one ordinary skill in the art from this disclosure, in one or more embodiments.

### REFERENCE NUMBERS

| | |
|---|---|
| 1 | detector |
| 10 | electromagnetic sensor |
| 11 | excitation coil |
| 12 | receiver |
| 12a | first receiver coil |
| 12b | second receiver coil |
| 15 | AC current unit |
| 20 | synchronization circuit |
| 21 | input terminal |
| 22 | voltage transformer |
| 24 | rectifier circuit |
| 25 | output circuit |
| 26 | voltage follower |
| 28 | comparator circuit |
| 30 | controller |
| 34 | Signal conditioning unit |
| 36 | ADC |
| 38 | microcontroller |
| 39 | trigger control unit |
| 50 | batch data sequence |
| 100 | continuous caster mold |
| 200 | EM stirrer |
| 220 | EM stirrer driver |
| 250 | three-phase power supply |
| 300 | liquid metal |

1. A detecting system (1) for monitoring and/or controlling liquid metal during a metal-making process, comprising:
an electromagnetic sensor (10) having an excitation coil (11) configured for generating a magnetic field interacting with the liquid metal being processed, and having a receiver (12) configured for detecting one or more response signals (R, R1, R2) revealing a variation of the magnetic field caused by eddy currents induced in the liquid metal,
an AC current unit (15) for energizing said excitation coil (11), and wherein the AC current unit is configured for receiving a start trigger signal and a stop trigger signal for respectively starting and stopping energizing the excitation coil,
characterized in that the detection system further comprises:
a synchronization circuit (20) comprising an input terminal (21) for receiving one or more AC phase voltages (V1, V2, V3) from a three-phase power supply, and wherein the synchronization circuit (20) is configured for outputting a pulse train (CLK) having a pulse train frequency f_{P} with f_{P}=M×f_{AC} and wherein M is an integer number with M≥1, and wherein f_{AC} is a frequency of an AC cycle associated to the one or more AC phase voltages,
a controller (30) configured for controlling said electromagnetic sensor (10) in a batch mode comprising consecutive batch cycles, and wherein each batch cycle comprises a first time window (AW) during which the excitation coil (11) is energized and acquisition of said one or more response signals (R, R1, R2) is performed, and one or more second time windows (DW, DW-P, DW-D) during which said excitation coil (11) is deenergized,
and wherein said controller (30) is further configured for receiving said pulse train (CLK) and for starting said first time windows (AW) by for each batch cycle selecting a pulse from said pulse train (CLK) and triggering a start of the AC current unit (15) with the pulse selected.

2. The detection system according to claim 1 wherein the controller (30) is configured for triggering a start signal for starting the acquisition of said one or more response signals (R, R1, R2), and wherein said triggering of the start signal for starting the acquisition is synchronized with the triggering of the start of the AC current unit (15).

3. The detection system according to claim 1 wherein a duration of the first time windows (AW) is specified by a pre-defined time period, and wherein the controller (30) comprises an internal clock for controlling when said pre-defined time period has lapsed.

4. The detection system according to claim 3 wherein said controller (30) is configured for stopping the first time windows (AW) by monitoring for each batch cycle a time lapse since the start of the first time window (TW) and if the pre-defined time period has lapsed then triggering a stop of said AC current unit (15).

5. The detection system according to claim 4 wherein said controller (30) is configured for triggering a stop signal for stopping said acquisition of the one or more response signals, and wherein said triggering of the stop signal for stopping acquisition of the one or more response signals is synchronized with said triggering of the stop of the AC current unit.

6. The detection system according to claim 3 wherein said pre-defined time period is specified as being equal to K×1/f_{C} wherein K is an integer number with K≥1 and wherein f_{C} corresponds to an AC excitation frequency for energizing the excitation coil (11).

7. The detection system according to claim 6 wherein each pulse of said pulse train (CLK) comprises a rising edge and a falling edge, and wherein said controller (30) comprises a trigger control unit (39) configured for detecting the rising edge or the falling edge of the pulses of the pulse train.

8. The detection system according to claim 1 wherein the synchronization circuit (20) comprises a voltage transformer (22) for stepping down the one or more AC phase voltages received to lower AC voltages, a rectifier circuit (24) coupled to the voltage transformer (22) and configured for rectifying AC currents and generating analogue voltage pulses, and an output circuit (25) configured for generating a train of digital pulses in synchrony with the analogue voltage pulses generated by the rectifier circuit (24), and wherein said train of digital pulses is forming said pulse train (CLK).

9. The detection system according to claim 8 wherein the voltage transformer comprises a set of three transformer coils coupled in a delta-configuration or in a star-configuration.

10. The detection system according to claim 1 wherein said controller (30) is configured for repeating said batch cycles at a fixed batch frequency, and wherein said selecting of a pulse from the pulse train (CLK) for each batch cycle comprises: detecting a firstly arriving pulse since a start of a new batch cycle and selecting said firstly arriving pulse for triggering the start of the AC current unit.

11. The detection system according to claim 10 wherein the fixed batch frequency is lower than the frequency of the pulse train (CLK).

12. The detection system according to claim 1 wherein said controller (30) is configured for repeating said batch cycles at a batch frequency f_{B} that is determined by a frequency f_{P} of the pulse train (CLK), wherein f_{B}=f_{P}/N with N being an integer number and N≥1 and wherein said selecting a pulse from the pulse train (CLK) for each batch cycle is performed by selecting a pulse of the pulse train every N^{the} pulses.

13. The detection system according to claim 1 wherein the integer number M is selected from any of: 1, 2, 3 or 6.

14. The detection system according to claim 1 wherein the input terminal of the synchronization circuit is configured for receiving two AC phase voltages from the three-phase power supply and wherein the synchronization circuit is configured to generate said pulse train based on said two AC phase voltages.

15. A continuous metal casting system comprising
a continuous caster mold (100) for receiving liquid metal (300),
an EM mold stirrer (200) coupled to the continuous caster mold (100), a driver (220) for driving the EM mold stirrer and a three-phase power supply (250) for powering the driver (220),
a detection system according to any of previous claims wherein one or more phase voltage lines of the three-phase power supply (250) are connected to said input terminal (21) of the synchronization circuit (20).

16. The detection system according to claim 6 wherein K≥2.

17. The detection system according to claim 6 wherein K≥3.

18. The detection system according to claim 10 wherein the fixed batch frequency is in a range between 20 Hz and 150 Hz.

19. The detection system according to claim 10 wherein the fixed batch frequency is in a range between 25 Hz and 100 Hz.

20. The detection system according to claim 13 wherein the integer number M=2.
